(19) United States
(12) Patent Application Publication
(10) Pub. No.: US 2024/0347243 A1
(43) Pub. Date: Oct. 17, 2024

(54) COATED MAGNETIC MATERIAL AND METHOD OF PRODUCING COATED MAGNETIC MATERIAL

(71) Applicant: NICHIA CORPORATION, Anan-shi (JP)

(72) Inventors: Ryoya OKAZAKI, Anan-shi (JP); Jun NISHITSUJI, Anan-shi (JP); Satoshi ABE, Tokushima-shi (JP); Jun AKAMATSU, Tokushima-shi (JP); Nobuyoshi IMAOKA, Anan-shi (JP)

(73) Assignee: NICHIA CORPORATION, Anan-shi (JP)

(21) Appl. No.: 18/634,272

(22) Filed: Apr. 12, 2024

(30) Foreign Application Priority Data
Apr. 14, 2023 (JP) 2023-066602

(51) Int. Cl. H01F 1/153

(52) U.S. Cl. CPC H01F 1/15383; H01F 1/15308

(57) ABSTRACT

A method of producing a coated magnetic material, including: a coating procedure including mixing an aqueous solution containing a phosphate compound and a compound of a metallic element or a semimetallic element with a soft magnetic material to form a coating containing phosphate and the metallic element or the semimetallic element on a surface of the soft magnetic material; and a pH adjustment procedure including mixing an aqueous solution containing a phosphate compound and a compound of a metallic element or a semimetallic element with the soft magnetic material on which the coating is formed, and adjusting a pH of a mixture of the aqueous solution and the soft magnetic material on which the coating is formed to form a coating containing phosphate and the metallic element or the semimetallic element on a surface of the soft magnetic material on which the coating is formed.

### CROSS-REFERENCE TO RELATED PATENT APPLICATION

This application claims priority to Japanese Patent Application No. 2023-066602 filed on Apr. 14, 2023. The disclosure of Japanese Patent Application No. 2023-066602 is hereby incorporated by reference in its entirety.

### BACKGROUND

The present disclosure relates to a coated magnetic material and a method of producing such a coated magnetic material.

Powder magnetic cores molded from soft magnetic powders are used as magnetic core materials for motors, transformers, and other electrical equipment.

When a soft magnetic powder is molded as it is, eddy currents can be generated throughout the resulting component due to conduction between the powder particles, resulting in higher iron loss. Japanese Patent publication No. 2011-127201 discloses a method of forming a coating containing hydroxyapatite on the surface of a soft magnetic powder in order to reduce iron loss in the resulting powder magnetic core. Japanese Patent publication No. H06-132109 discloses a method of forming a glassy insulating layer containing Cr or P as an essential element on the surface of a soft magnetic powder.

### SUMMARY

Embodiments of the present disclosure aim to provide a coated magnetic material having a coating with good heat resistance and a method of producing the same.

Exemplary embodiments of the present disclosure relate to a method of producing a coated magnetic material, including: a coating procedure including mixing a first aqueous solution containing a first phosphate compound and a first compound of a first metallic element or a first semimetallic element with a soft magnetic material to form a first coating containing phosphate and the first metallic element or the first semimetallic element on a surface of the soft magnetic material; and a pH adjustment procedure including mixing a second aqueous solution containing a second phosphate compound and a second compound of a second metallic element or a second semimetallic element with the soft magnetic material on which the first coating is formed, and adjusting a pH of a mixture of the second aqueous solution and the soft magnetic material on which the first coating is formed to form a second coating containing phosphate and the second metallic element or the second semimetallic element on a surface of the soft magnetic material on which the first coating is formed.

Exemplary embodiments of the present disclosure relate to a coated magnetic material, including: a soft magnetic material; and a coating provided on a surface of the soft magnetic material, wherein the coating includes, in an order from a magnetic material side, a first region containing a first M component and phosphorus and a second region containing a second M component and phosphorus, an average amount of the first M component in the first region is less than an average amount of the second M component in the second region, and the first M component and the second M component are each at least one selected from the group consisting of Mo, W, Zn, Fe, Hf, Ti, Zr, Ni, Ca, Ba, Na, Cr, V, K, Mn, Mg, Si, and Ta.

The embodiments of the present disclosure can provide a coated magnetic material having a coating with good heat resistance and a method of producing the same.

### BRIEF DESCRIPTION OF DRAWINGS

FIG. 1 shows an example of line scan results of a coated magnetic material provided in Example 27.

FIG. 2 shows an example of line scan results of the coated magnetic material provided in Example 27.

### DETAILED DESCRIPTION

Embodiments of the present disclosure are described in detail below. The following embodiments, however, are intended as examples to embody the technical idea of the present disclosure and are not intended to limit the scope of the present disclosure to the following embodiments. As used herein, the term “procedure” encompasses not only an independent procedure but also a procedure that may not be clearly distinguished from other procedures, as long as a desired object of the procedure is achieved. Moreover, numerical ranges indicated using “to” refer to ranges including the numerical values before and after “to” as the minimum and maximum, respectively.

### Method of Producing Coated Magnetic Material

A method of producing a coated magnetic material according to the present embodiments includes a coating procedure including mixing an aqueous solution containing a phosphate compound and a compound of a metallic element or a semimetallic element with a magnetic material that is a soft magnetic material to form a coating containing phosphate and the metallic element or the semimetallic element on a surface of the magnetic material; and a pH adjustment procedure including mixing an aqueous solution containing a phosphate compound and a compound of a metallic element or a semimetallic element with the magnetic material on which the coating is formed, and adjusting a pH of a mixture of the aqueous solution and the magnetic material on which the coating is formed to form a coating containing phosphate and the metallic element or the semimetallic element on a surface of the magnetic material on which the coating is formed.

### Magnetic Material

In the present embodiments, the magnetic material used is a soft magnetic material. The soft magnetic material is a material with low coercivity and high saturation flux density. Examples of the soft magnetic material include oxide-based soft magnetic materials and metal-based soft magnetic materials. The soft magnetic material can be a material with a coercivity of not more than 10 Oe (795.8 A/m) and a saturation flux density of at least 0.3 T. The soft magnetic material can be a material with a coercivity of not more than 5 Oe (397.9 A/m) and a saturation flux density of at least 1.0 T.

Examples of the oxide-based soft magnetic materials include materials containing an iron oxide and a transition metal such as Ni, Zn, Cu, Mn, or Co. Specific examples include Mn—Zn-based soft ferrites, Ni—Zn-based soft ferrites, and Cu—Zn-based soft ferrites. Examples of the metal-based soft magnetic materials include pure irons, Fe—X alloys (X: Ti, Mn, Ni, Co, Zr, Hf, V, Nb, Ta, Cr, Mo, W, Cu, Zn, Si), silicon steels (Fe—Si), Sendusts (Fe—Si—Al), Permendurs (Fe—Co), permalloys (Fe—Ni), electromagnetic stainless steels (Fe—Cr), and rapidly quenched ribbon powders (Fe—Si—B, Fe—Si—B—P—Cu). Examples of the pure irons include atomized iron, reduced iron, electrolytic iron, and carbonyl iron.

An Fe—X alloy includes a first phase containing Fe and X and a second phase containing X and having an X content that, when the sum of Fe and X in the second phase is taken as 100 atom %, is higher than the X content of the first phase when the sum of Fe and X in the first phase is taken as 100 atom %. The use of an Fe—X alloy as a soft magnetic material can further improve heat resistance. X is at least one selected from Ti, Mn, Ni, Co, Zr, Hf, V, Nb, Ta, Cr, Mo, W, Cu, Zn, and Si, and at least two of these may be selected. The first phase of the Fe—X alloy may have crystals with a bcc structure containing Fe and X. Preferably, except when X includes Co, both the first and second phases of the Fe—X alloy have crystals with a bcc structure containing Fe and X. This can improve magnetization. The crystallite size of the bcc phase in the first and/or second phase of the Fe—X alloy is preferably at least 1 nm but less than 100 nm. X can include Ni and/or Co and other additional components. In this case, the additional component content in the second phase is preferably higher than the additional component content in the first phase. The additional component contents in the first and second phases each refer to the additional component content (atom %) when the sum of X components including additional components and Fe in the corresponding first or second phase is taken as 100 atom %. This allows both low coercivity and improved magnetization to be achieved.

When the first and second phases have crystals with a bcc structure containing Fe and X components, the ratio of the X component content in the second phase to the X component content in the first phase, the second phase/first phase X component ratio, can be at least 1, and may be at least 1.1 but not more than 10¹. The X component contents in the first and second phases each refer to the X component content (atom %) when the sum of Fe and X in the corresponding first or second phase is taken as 100 atom %. Such a second phase/first phase X component ratio allows both low coercivity and high magnetization to be achieved, and is thus suitable for a soft magnetic material with good high-frequency characteristics.

When the X components include Ti or Mn, the ratio of the Ti or Mn content in the second phase to the Ti or Mn content in the first phase, the second phase/first phase component ratio for Ti or Mn, is preferably at least 2 but not more than 10′. When the X components include one of Zr, Hf, V, Nb, Ta, Cr, Mo, W, Cu, Zn, and Si, the second phase/first phase component ratio for the corresponding component is preferably at least 1.5 but not more than 10′. When the X components include Ni or Co, the second phase/first phase component ratio for the corresponding component is preferably more than 1, more preferably at least 1.1 but not more than 10¹. These second phase/first phase X component ratios make it possible to achieve both low coercivity and high magnetization and, for example, to obtain a soft magnetic material with a coercivity of not more than 10 Oe and a magnetization of at least 0.3 T. Such a soft magnetic material can be used to achieve lower losses in high-frequency applications. The Fe—X alloy can have a structure in which the nanoscale first and second phases are connected by ferromagnetic bonds due to the presence of nano-order X compositional fluctuations caused by disproportionation reactions during reduction. Such a structure probably leads to low coercivity and high magnetization. The Fe—X alloy can be obtained, for example, as described in WO 2017/164376 or WO 2018/155608.

The soft magnetic materials listed above may be used alone or in combinations of two or more. Among the soft magnetic materials, metal-based soft magnetic materials are preferred. This is because, when a metal-based soft magnetic material is used and coated as described later, it is easier to increase the electrical resistance of the magnetic material molded product and reduce losses, thus improving magnetization. Among the metal-based soft magnetic materials, pure irons or Fe—X alloys are preferred. In particular, Fe—X alloys with X being Mn (such alloys are referred to as “Fe—X (X=Mn)”), Fe—X alloys with X being Ni (such alloys are referred to as “Fe—X (X=Ni)”), or Fe—X alloys with X being Mn and Ni (such alloys are referred to as “Fe—X (X=Mn, Ni)”) are more preferred. These components listed as X may be X main components. When X=Mn, Ni, other components may be included in an amount smaller than the amount of Mn, Ni. More preferably, X consists substantially only of Mn and Ni. Fe—X (X=Mn) tends to have higher electrical resistance and heat resistance than Fe powder (pure iron) does. This is probably due to the inclusion of an X component-enriched phase. Fe—X (X=Ni) shows higher magnetization when the Ni content is higher than 0 but not higher than 12 atom %, as expected from the Slater-Pauling curve. Fe—X (X=Mn, Ni) can have the advantages of both Fe—X (X=Mn) and Fe—X (X=Ni). In other words, it is possible to increase electrical resistance and therefore reduce eddy current loss, and improve heat resistance and magnetization.

When the magnetic material is an Fe—X alloy in a powder form, the Fe—X alloy can be provided, for example, by reducing a ferrite powder, which mainly contains an X component not easily reduced by hydrogen, in a reducing gas containing hydrogen gas, followed by a disproportionation reaction to form a first phase and a second phase. The resulting Fe—X alloy powder thus has a relatively large specific surface area with X component compositional fluctuations. The large specific surface area increases the bonding force to the coating, and the nanoscale X component fluctuations can strengthen the bond between the M component contained in the coating, which will be described later, and the X component when the M component has affinity for the X component. Probably for one or both of these reasons, an M component-containing coating can be easily formed on the surface of the magnetic material with good adhesion. When using an Fe—X alloy as a magnetic material, not only hysteresis loss but also eddy current loss can be reduced and iron loss can be improved compared to, for example, when using a pure iron as a magnetic material. Thus, the magnetic material used to form an M component-containing coating in the present embodiments is preferably an Fe—X alloy.

The magnetic material used is preferably in a powder form to facilitate the formation of a powder magnetic core of any shape. The particle size D50 of the magnetic powder can be, for example, at least 1 m but not more than 5 mm, preferably at least 5 m but not more than 1 mm, more preferably at least 10 m but not more than 500 μm. In this range, coercivity can be reduced, and distortions during annealing can be reduced. Herein, the particle size D50 refers to the particle size corresponding to 50% of the cumulative particle size distribution by volume of the magnetic powder.

The coating procedure is preferably preceded by washing the magnetic material with an acidic aqueous solution to remove the impurities and oxide layer on the surface of the magnetic material. The acid compound used in the washing may be an inorganic or organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, and tartaric acid. The pH during the washing is preferably less than pH 7, more preferably less than pH 3. The washing time is preferably at least one minute but not more than 10 hours. During the washing, the aqueous solution is preferably stirred.

### Coating Procedure

In the coating procedure, an aqueous solution containing a phosphate compound and a compound of a metallic element or a semimetallic element is mixed with a magnetic material that is a soft magnetic material. As a result, the metal component in the magnetic material is reacted with the phosphate component and the metallic element or semimetallic element to form a coating containing phosphate and the metallic element or semimetallic element on the surface of the magnetic material. The metallic element or semimetallic element of the compound contained in the aqueous solution is also referred to as the M component in the present embodiments.

Examples of the phosphate compound contained in the aqueous solution include orthophosphoric acid, sodium dihydrogen phosphate, sodium monohydrogen phosphate, ammonium dihydrogen phosphate, ammonium monohydrogen phosphate, zinc phosphate, calcium phosphate, and other phosphates, hypophosphorous acid and hypophosphites, pyrophosphoric acid, polyphosphoric acid, and other inorganic phosphoric acids, and organic phosphoric acids, and salts thereof. These may be used alone or in combinations of two or more.

The amount of the phosphate compound, calculated as PO₄, in the aqueous solution is preferably at least 0.0001% by mass but not more than 50% by mass, more preferably at least 0.001% by mass but not more than 10% by mass. In such a range, the phosphate compound tends to have high solubility in water and high storage stability.

Examples of the metallic element as the M component include transition metal elements such as Ti, Zr, Hf, V, Nb, Ta, Cr, Mo, W, Mn, Fe, Ru, Co, Ni, Pd, Pt, Ag, and Au; rare earth metal elements such as Ce, Sm, La, Dy, Nd, Y, and Pr; alkali metal elements such as Li, Na, K, Rb, and Cs; alkaline earth metal elements such as Ca, Sr, and Ba; and typical metallic elements except semimetals, such as Zn, Cd, and Al. Examples of the semimetallic element as the M component include B, Si, and Ge.

In order to obtain a coated magnetic material with good heat resistance, the element used as the M component is preferably a metallic element which has a relatively small Gibbs free energy change (AG) for the oxidation reaction in the temperature range (e.g., at least 400° C. but not higher than 700° C.) when the coated magnetic material is heated. The element used as the M component preferably has a Gibbs free energy change for the oxidation reaction at 600° C. that is not greater than −300 kJ/mol O₂. The M component is preferably at least one selected from Mo, W, Zn, Fe, Hf, Ti, Zr, Ni, Ca, Ba, Na, Cr, V, K, Mn, Mg, Si, Ta, Nb, Al, Ce, La, Nd, Sm, and Dy, more preferably at least one selected from Mo, W, Zn, Fe, Hf, Ti, Zr, Ni, Ca, Ba, Na, Cr, V, K, Mn, Mg, Si, and Ta. The Gibbs free energy changes for the oxidation reactions at 600° C. of metallic element oxides are shown in Table 1.

TABLE 1

| Element | Δ G for oxidation at 600° C. [kJ/mol O₂] |
|---|---|
| Ca | −1086.9 |
| Cu | −212.4 |
| Ni | −320.2 |
| W | −416.2 |
| Fe | −420.2 |
| Mo | −432.9 |
| K | −482.7 |
| Zn | −523.6 |
| Na | −596.4 |
| Cr | −599.1 |
| Mn | −641.8 |
| Ta | −666.0 |
| Nb | −675.2 |
| V | −709.6 |
| Si | −752.5 |
| Ti | −900.0 |
| Ce | −907.9 |
| Hf | −910.8 |
| Zr | −931.7 |
| Ba | −933.4 |
| Al | −934.8 |
| Mg | −1014.9 |
| La | −1028.5 |
| Nd | −1039.9 |
| Sm | −1046.5 |
| Dy | −1069.1 |

Elements having a Gibbs free energy change (AG) for the oxidation reaction at 600° C. that is greater than −300 kJ/mol O₂ can be easily reduced by Fe, and are therefore prone to become a metallic state in the purification/coating fixation procedure described later or the heating procedure in the method of producing a molded product described later. This tends to result in an increase in eddy current loss and a decrease in efficiency. Using a magnetic powder provided with a coating containing a metallic element with a relatively small Gibbs free energy change (AG) for the oxidation reaction, it is possible to reduce such an increase in eddy current loss due to heating. This permits straightening annealing at a relatively high temperature of, for example, at least 400° C. but not higher than 700° C., which can reduce hysteresis loss and thus overall iron loss.

The compound of the metallic element or semimetallic element added to the aqueous solution is a different compound from the phosphate compound added to the aqueous solution. Examples of the compound of the metallic element or semimetallic element include metallic element or semimetallic element oxides, oxoacids, chlorides, hydroxides, and oxoacid compounds such as sulfates, nitrates, acetates, phosphates, and carbonates, with oxoacid compounds being preferred. Among these, metal oxoacid compounds are preferred, and transition metal oxoacid compounds are more preferred. The compounds of metallic elements or semimetallic elements listed above may be used alone or in combinations of two or more.

The amount of the compound of the metallic element or semimetallic element in the aqueous solution is preferably at least 0.001% by mass but not higher than 10% by mass, more preferably at least 0.01% by mass but not higher than 5% by mass. In such a range, the compound tends to have high solubility in water and high storage stability.

The coating formation reaction time in the coating procedure is preferably at least one minute but not more than 10 hours, more preferably at least five minutes but not more than two hours.

The main component of the reaction solvent used in the coating procedure is water, and the reaction solvent may be a solvent mixture of water and a hydrophilic organic solvent. When these solvents are used, a smaller particle size phosphate may precipitate to form a denser coating than when hydrophobic organic solvents are used. When a solvent mixture of water and a hydrophilic organic solvent is used, examples of the hydrophilic organic solvent include ethanol, methanol, 2-propanol, acetone, and 2-butanone. The amount of the hydrophilic organic solvent in the solvent mixture is preferably at least 0.1% by mass but not more than 80% by mass, more preferably at least 1% by mass but not more than 50% by mass.

In the coating procedure, the amount of the magnetic material in the mixture of the aqueous solution containing the phosphate compound and the compound of the metallic element or semimetallic element and the magnetic material, is preferably at least 0.0001% by mass but not more than 70% by mass, more preferably at least 0.01% by mass but not more than 10% by mass. In such a range, the thickness of the coating tends to be stable.

In the coating procedure, as long as an aqueous solution containing a phosphate compound and a compound of a metallic element or semimetallic element can be ultimately mixed with a magnetic material that is a soft magnetic material, the components may be mixed in any order. In the coating procedure, preferably, an aqueous solution containing the compound of the metallic element or semimetallic element is firstly mixed with the magnetic material and then with the phosphate compound. Mixing an aqueous solution containing the compound of the metallic element or semimetallic element with the magnetic material in advance allows the compound of the metallic element or semimetallic element to easily adhere or bind to the surface of the magnetic material, making it possible to increase the amount of the coating containing a phosphorus compound. When the aqueous solution containing the compound of the metallic element or semimetallic element is mixed with the magnetic material in advance, the mixture obtained by mixing them may be stirred preferably at a pH of at least 2 but not higher than 12, more preferably at a pH of at least 4 but not higher than 10, still more preferably at a pH of at least 5 but not higher than 8, preferably for at least one minute, more preferably at least five minutes, before adding an aqueous solution containing the phosphate compound.

After the coating procedure but before the pH adjustment procedure, the magnetic material on which the coating is formed may be purified. The magnetic material on which the coating is formed can be purified, for example, by heating at at least 100° C. but not higher than 500° C. or by filtration with a filter.

### pH Adjustment Procedure

In the pH adjustment procedure, an aqueous solution containing a phosphate compound and a compound of a metallic element or a semimetallic element is mixed with the magnetic material on which the coating is formed in the coating procedure to adjust the pH of the mixture of the aqueous solution and the magnetic material on which the coating is formed. If the pH adjustment is not performed, the pH of the aqueous solution may increase as the phosphate derived from the phosphate compound adheres to the magnetic material, which may inhibit the coating formation. The pH adjustment can promote the coating formation.

The aqueous solution containing a phosphate compound and a compound of a metallic element or semimetallic element and the solvent used in the pH adjustment procedure may be of the types described for the coating procedure. Moreover, they may each be of the same type as or different type from that in the coating procedure.

In particular, when the compound of the metallic element or semimetallic element used in the pH adjustment procedure is of a different type from the compound of the metallic element or semimetallic element used in the coating procedure, the metallic element or semimetallic element used in the coating procedure and the metallic element or semimetallic element used in the pH adjustment procedure tend to accumulate in the vicinity of the base material magnetic material and the surface of the coating, respectively, in the thickness direction of the coating to be finally formed.

Moreover, the aqueous solution used in the pH adjustment procedure may be obtained by adding a phosphate compound and/or a compound of a metallic element or semimetallic element to the aqueous solution used in the coating procedure. At this time, the pH adjustment procedure can be performed after the coating procedure without purifying the magnetic material on which the coating is formed.

The amount of the phosphate compound, calculated as PO₄, in the aqueous solution used in the pH adjustment procedure is preferably at least 0.0001% by mass but not more than 50% by mass, more preferably at least 0.001% by mass but not more than 10% by mass. In such a range, the phosphate compound tends to have high solubility in water and high storage stability.

The amount of the compound of the metallic element or semimetallic element in the aqueous solution used in the pH adjustment procedure is preferably at least 0.001% by mass but not more than 10% by mass, more preferably at least 0.01% by mass but not more than 5% by mass. In such a range, the compound of the metallic element or semimetallic element tends to have high solubility in water and high storage stability.

The amount of the magnetic material in the mixture of the magnetic material and the aqueous solution containing the phosphate compound and the compound of the metallic element or semimetallic element used in the pH adjustment procedure is preferably at least 0.0001% by mass but not more than 90% by mass, more preferably at least 0.01% by mass but not more than 10% by mass. In such a range, the thickness of the coating tends to be stable.

The pH is preferably adjusted within a range lower than the pH of the mixture of the magnetic material and the aqueous solution used in the coating procedure, more preferably lower by at least 0.01, still more preferably lower by at least 0.1, further preferably lower by at least 1. Specifically, the pH is preferably adjusted within a range of at least 0 but lower than 7, more preferably at least 1 but not higher than 4.5, still more preferably at least 1.6 but not higher than 3.9, further preferably at least 2 but not higher than 3. If the pH is lower than 0, etching of the magnetic material may dominate, resulting in insufficient coating formation. When the pH is at least 1, the rate of phosphate precipitation can be reduced to make it easier to control the thickness of the coating to be formed as compared to when the pH is lower. If the pH is not lower than 7, the coating tends to be insufficient due to a decrease in the amount of phosphate precipitation, resulting in increased losses. Thus, the pH is preferably lower than 7. When the pH is not higher than 4.5, the rate of phosphate precipitation can be not too low.

The acid to be added in the pH adjustment may be an inorganic acid or an organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, and tartaric acid. Although an inorganic acid is preferably used in view of liquid waste disposal, an organic acid may be used together depending on the purpose. An inorganic acid and an organic acid may be used in admixture.

The coating formation reaction time in the pH adjustment procedure is preferably at least one minute but not longer than 20 hours, more preferably at least five minutes but not longer than 10 hours. The inorganic acid may be added as needed to adjust the pH within the above-mentioned range during the pH adjustment procedure. In the initial stage of the coating procedure, where the pH increases rapidly, the inorganic acid for pH adjustment is preferably introduced at short intervals.

### Purification/Coating Fixation Procedure

The pH adjustment procedure may be followed by purifying the coated magnetic material. In the coated magnetic material purification procedure, the liquid component can be removed, for example, by heating at at least 100° C. but not higher than 800° C. or by filtration with a filter.

The pH adjustment procedure may also be followed by fixing the coating. In the coating fixation procedure, the purified coated magnetic material may be treated at a high temperature so that the phosphorus is baked onto the magnetic material. The temperature conditions of the high temperature treatment are preferably at least 50° C. but not higher than 500° C., more preferably at least 100° C. but not higher than 300° C. The high temperature treatment time is preferably at least one minute but not more than 100 hours, more preferably at least 10 minutes but not more than 10 hours.

### Coated Magnetic Material

A coated magnetic material according to the present embodiments includes a magnetic material that is a soft magnetic material, and a coating provided on a surface of the magnetic material. The particle size D50 of the coated magnetic material produced in the present embodiments is preferably at least 1 m but not more than 5 mm, more preferably at least 5 m but not more than 1 mm, still more preferably at least 10 m but not more than 500 m. In such a range, coercivity can be reduced, and distortions during annealing can be prevented. Herein, the particle size D50 refers to the particle size corresponding to 50% of the cumulative particle size distribution by volume of the coated magnetic material.

Preferably, oxygen is present in a larger amount than phosphorus in the coating. In this case, there is at least some region where oxygen is present in a larger amount than phosphorus in the thickness direction of the coating. The region where oxygen is present in a larger amount than phosphorus preferably accounts for at least 10%, more preferably at least 50%, still more preferably the entire region, in the thickness direction of the coating. The amount of oxygen is preferably more than one times the amount of phosphorus, and can be at least two times, or may be at least three times, the amount of phosphorus. The upper limit of the amount of oxygen can be, for example, not more than 10 times the amount of phosphorus.

The coating contains phosphorus and an M component (metallic element or semimetallic element). The phosphorus may be in the form of phosphate. The thickness of the coating is preferably at least 1 nm but not more than 10 m, more preferably at least 5 nm but not more than 500 nm, in terms of the insulating properties and heat resistance of the coated magnetic material. The thickness of the coating can be measured by compositional analysis using an energy dispersive X-ray analysis (EDX) line scan of a cross-section of the coated magnetic material.

In the coated magnetic material, the amount of the metallic element or semimetallic element adhered in the coating procedure and the pH adjustment procedure is preferably at least 0.01% by mass but not more than 0.25% by mass, more preferably at least 0.03% by mass but not more than 0.2% by mass, still more preferably at least 0.04% by mass but not more than 0.18% by mass. In the above range, the insulating properties of the coated magnetic material can be easily improved, and the iron loss can be easily reduced. The amount of the metallic element or semimetallic element in the coated magnetic material can be measured by ICP atomic emission spectroscopy (ICP-AES).

The coating according to the present embodiments can include, in order from the magnetic material side, a first region containing a first M component and phosphorus and a second region containing a second M component and phosphorus. The average amount of the first M component in the first region is lower than the average amount of the second M component in the second region. The first M component and the second M component are each at least one selected from the group consisting of Mo, W, Zn, Fe, Hf, Ti, Zr, Ni, Ca, Ba, Na, Cr, V, K, Mn, Mg, Si, and Ta. The coated magnetic material produced with such a coating can exhibit good heat resistance. The first M component and the second M component may be the same as or different from each other. For example, the first M component and the second M component are the same element.

The coating according to the present embodiments may include, in the direction from its surface toward the magnetic material, a layer or region containing mainly an M component in a somewhat constant amount (referred to as an H layer) and a layer or region containing an M component in an amount that decreases and then again becomes somewhat constant (referred to as an L layer). In the direction from the L layer toward the magnetic material, the amount of the M component may further decrease until the surface of the magnetic material. The somewhat constant amount of the M component in the H layer means that the amount falls within a range of ±50% of the average amount in the H layer. The somewhat constant amount of the M component in the L layer means that the amount falls within a range of ±100% of the average amount in the L layer. The ratio of the average amount of the M component in the L layer to the average amount of the M component in the H layer is preferably from 0.1 to 0.9, more preferably from 0.15 to 0.7, still more preferably from 0.2 to 0.5.

It is presumed that the H layer and the L layer can be formed in the pH adjustment procedure and the coating procedure, respectively. An M component may be added in the coating procedure to form a base L layer. Then, an M component may be added in the pH adjustment procedure to form a compound of the M component in the presence of the L layer. This can increase the amount of the M component in the resulting H layer, thereby improving heat resistance. Moreover, the presence of the base L layer can reduce rapid changes in the compositional percentage of the M component, thereby improving the resistance of the coating to heat and mechanical stress. An I layer where the amount of the M component is between those of the H layer and the L layer may be present between the H layer and the L layer. The I layer can be easily formed by repeating the coating procedure and the pH adjustment procedure multiple times.

In the coating, each of the above metals may be present in either crystalline or amorphous form. The concentration (atom %) of each metal in the coating can be measured by compositional analysis using an EDX line scan of the coated magnetic material. The coating can contain a phosphate compound and/or composite oxide in microcrystalline form. The presence of a phosphate compound or composite oxide in microcrystalline form in the coating can increase mechanical strength and improve heat resistance.

In the coated magnetic material, the amount of phosphorus adhered in the coating procedure and the pH adjustment procedure is preferably at least 0.0001% by mass but not more than 50% by mass, more preferably at least 0.001% by mass but not more than 5% by mass. In the above range, the heat resistance tends to improve. The amount of phosphorus in the coated magnetic material can be measured by ICP atomic emission spectroscopy (ICP-AES).

The iron loss W of the coated magnetic material is preferably not more than 700 W/kg, more preferably not more than 420 W/kg. The lower limit of the iron loss W may be, for example, at least 10 W/kg. Here, these losses are measured at a maximum flux density (Bmax) of 1 T and a frequency of 1000 Hz as described in EXAMPLES. The present embodiments can provide such a numerical range to the molded product that has undergone a heating procedure. The heating temperature in the heating procedure can be 600° C., for example. The molded product with iron loss W and other losses within such numerical ranges may contain no resin and no glass. When the coated magnetic material, not the molded product, has undergone the heating procedure, the iron loss W of the coated magnetic material measured may be in the range described above.

### Method of Producing Molded Product

A method of producing a molded product according to the present embodiments includes obtaining a coated magnetic material and heating the coated magnetic material. The procedure of obtaining a coated magnetic material can be performed as described above for the method of producing a coated magnetic material.

### Heating Procedure

In the heating procedure, the coated magnetic material is heated. The heating temperature may be, for example, at least 100° C. but not higher than 1200° C. The heating procedure can be performed, for example, in order to release stress caused by pressurization and/or to partially react the coating of the coated magnetic material to obtain an integrated molded product. To release stress caused by pressurization, the heating temperature is preferably at least 300° C. but not higher than 1000° C., more preferably at least 400° C. but not higher than 700° C. As the coated magnetic material used in the present embodiments has a coating with good heat resistance, the losses of the coating can be reduced even after the heating procedure. The heating temperature may be at least 500° C. In this case, the molded product preferably does not contain resin or glass. This is because resin and glass are likely to degrade significantly at high temperatures of at least 500° C. The duration of the heating procedure is preferably at least one minute but not more than 100 hours, more preferably at least 10 minutes but not more than 10 hours. The heating procedure may be carried out in a nitrogen atmosphere or in the air, for example. The heating procedure is preferably carried out in an inert atmosphere such as an argon atmosphere or vacuum. When the magnetic material contains Fe, the heating procedure is preferably carried out in an inert atmosphere other than a nitrogen atmosphere because heating in a nitrogen atmosphere may nitride the magnetic material and deteriorate the characteristics of the magnetic material.

The heating procedure is preferably preceded by pressurizing the coated magnetic material to obtain a pressure molded product. In this case, the heating procedure corresponds to heating the pressure molded product obtained in the procedure of obtaining a pressure molded product.

The pressurization conditions are preferably at least 0.01 GPa but not higher than 10 GPa, more preferably at least 0.5 GPa but not higher than 5 GPa. The coated magnetic material may be disposed into a mold and then pressurized to obtain a pressure molded product of the desired shape. When a mold is used, a lubricant, which will be described later, may be applied to the inner walls of the mold cavity before disposing the coated magnetic material. Applying a lubricant to the inner walls of the mold cavity can improve the releasability of the pressure molded product from the mold.

In the pressurization, the coated magnetic material may be pressurized alone, but the coated magnetic material may be mixed with a binder, a lubricant, etc. before being pressurized. Examples of the binder include thermosetting resins such as epoxy resins, urethane resins, phenol resins, methacrylic resins, acrylic resins, and silicone resins, and thermoplastic resins such as polyamide resins. The amount of the binder used per 100 parts by mass of the coated magnetic material is preferably at least 0.01 parts by mass but not more than 1000 parts by mass, more preferably at least one part by mass but not more than 50 parts by mass. When the amount of the binder used is within the above range, a molded product with good mechanical strength and low iron loss can be obtained.

Examples of the lubricant include metallic soaps such as zinc stearate, calcium stearate, and lithium stearate, amines or amides such as 1,2-bis(stearoylamino)ethane, long chain hydrocarbons such as waxes, and silicone oils. The amount of the lubricant used per 100 parts by mass of the coated magnetic material is preferably at least 0.00001 parts by mass but not more than 10 parts by mass, more preferably at least 0.01 parts by mass but not more than 5 parts by mass. When the amount of the lubricant used is within the above range, the releasability of the pressure molded product from the mold cavity can be improved.

The filling ratio of the molded product obtained in the present embodiments can be at least 10% but not higher than 100%, preferably at least 80% but not higher than 100%. The filling ratio here refers to the ratio (percentage) of the molded product density to the true density. The ratio (percentage) of the volume of the coated magnetic material to the volume of the molded product obtained in the present embodiments may be at least 40% but not higher than 100%, preferably at least 80% but not higher than 100%. The ratio of the area of the coated magnetic material to the area of the molded product in a cross-section of a portion of the molded product may be regarded as the ratio of the volume of the coated magnetic material to the volume of the molded product.

Because the molded product obtained in the present embodiments is an aggregate of the coated magnetic material having a coating with good heat resistance, the coating is maintained after the heating procedure, and losses such as iron loss can be reduced. After the heating procedure, the coatings of the individual coated magnetic material particles may partially react to fuse and integrate with the coatings of the adjacent coated magnetic material particles while maintaining the insulation between the magnetic material particles. The molded product according to the present embodiments can be obtained from the coated magnetic material without using a binder such as resin or glass. Resin can give rise to eddy currents when carbonized by heat treatment. Glass can also be degraded by heat treatment. For these reasons, when a binder such as resin or glass is used, the temperature of the heat treatment, if performed, is preferably relatively low. In the case of a molded product containing no resin or glass, even when heated at a relatively high temperature such as 500° C. or higher, it is possible to reduce the increase in losses. Moreover, heating at a relatively high temperature can more effectively release stress caused by pressurization. Moreover, the combined use with the lubricant described above can increase the molded product density and allow the adjacent coated magnetic material particles to be bonded through a chemical reaction, thereby improving mechanical strength.

### EXAMPLES

Examples are described below. It should be noted that “%” is by mass unless otherwise specified.

### (1) Evaluation Method

### (1-1) Iron Loss

The magnetic powder was disposed into a mold having an inner diameter of 10 mm and an outer diameter of 14 mm, molded at an increased pressure of 1 GPa, and then heat-treated in an Ar atmosphere at 600° C. for one hour to provide a toroidal molded product. The molded product was wound with a copper wire by 50 turns on the primary side and 50 turns on the secondary side to provide an evaluation sample. The evaluation sample was evaluated for W10/1000 (iron loss at 1000 Hz and 1 T) using a B—H analyzer (SY-8218, available from Iwatsu Electric Co., Ltd.).

### (1-2) Coating Thickness and Atomic Concentrations

The coating thickness and atomic concentrations of the coated magnetic material were measured as follows. First, the provided coated magnetic material was molded into a φ10-mm disk and heated in an Ar atmosphere at 600° C. for one hour to provide a molded product. The molded product was embedded in EpoxiCure resin and then processed by ion milling, from which a sample was taken out by a microsampling method and then sectioned by focused ion beam (FIB). The respective values of the resulting sample were estimated using a scanning transmission electron microscope (STEM; available from JEOL; acceleration voltage 200 kV) and an energy dispersive X-ray analyzer (EDX; available from JEOL). To determine the atomic concentrations in the coating, a line scan was performed in steps of 0.24 nm from the exterior to the interior of the coated magnetic material to observe continuous changes in the atomic concentrations of the constituent elements, thereby determining a region where the atomic concentration of phosphorus (P) was at least 1 atom %. Here, because a lot of carbon (C) from the resin used to provide the cross-sectional sample might be detected in some measurement points, the atomic concentrations were calculated based on the total elements, excluding C.

### (2) Examples 1 to 28, Comparative Examples 1 to 3

### (2-1) Production of Coated Magnetic Material

### (i-i) Provision of Soft Magnetic Material: Examples 1 and 2, Comparative Examples 1 and 2

A commercially available water-atomized iron powder was provided as a soft magnetic material (magnetic material) in Examples 1 and 2 and Comparative Examples 1 and 2.

### (i-ii) Provision of Soft Magnetic Material: Examples 3 to 28, Comparative Example 3

A Fe—X alloy was provided as a soft magnetic material (magnetic material) in Examples 3 to 28 and Comparative Example 3. The Fe—X alloy was produced as follows. First, an aqueous solution was provided from MnCl₂·4H₂O (manganese(II) chloride tetrahydrate), NiCl₂·6H₂O (nickel(II) chloride hexahydrate), and FeCl₂·4H₂O (iron(II) chloride tetrahydrate) as raw materials. The aqueous solution and potassium hydroxide as a pH adjuster were used to provide a Mn—Ni-ferrite. The ferrite was heated at 12° C./min to 950° C. and then at 2° C./min to 1050° C., followed by reduction treatment at 1050° C. for one hour in a hydrogen atmosphere. The resulting product was quenched to room temperature and then slowly oxidized in an argon atmosphere at an oxygen partial pressure of 3% by volume for 30 minutes to obtain a soft magnetic material with a composition of Fe₉₆Ni_{3.9}Mn_{0.1}. The D₅₀ of the Fe—Ni—Mn powder was 250 μm.

### (ii) Washing of Soft Magnetic Material

The soft magnetic material listed in Table 2 in an amount of 10 g was added to an aqueous solution adjusted to pH 1.1 or lower with dilute hydrochloric acid, followed by stirring for ten minutes to remove the oxidized surface layer and contaminants.

### (iii) Coating Procedure

To the washed soft magnetic material was added an aqueous solution containing 10% by mass of the compound of a metallic element or semimetallic element listed in Table 2 relative to the amount of the soft magnetic material, and the mixture was stirred for 15 minutes. Subsequently, an aqueous phosphate solution at pH 2 containing 4% by mass of the phosphate compound listed in Table 2 relative to the amount of the soft magnetic material was added, followed by stirring for seven minutes. The final concentration of each component was as follows: 1.6% by mass of the soft magnetic material, 0.16% by mass of the compound of the metallic element or semimetallic element, and 0.4% by mass of the phosphate compound (calculated as PO₄). The pH of the treatment tank rose from 3 to 5.

### (iv) pH Adjustment Procedure

An aqueous solution containing 10% by mass of the compound of a metallic element or semimetallic element listed in Table 2 relative to the amount of the coated magnetic material was added, and the reaction mixture was stirred for 30 minutes while the pH of the reaction mixture was controlled within the range of 2.5±0.1 by introducing 6% by mass of hydrochloric acid as needed.

### (v) Drying and Baking

The coated magnetic material after the pH adjustment procedure was dried by heating at 100° C. for four hours under vacuum conditions. The coating was then baked by heating at 200° C. for four hours.

### (2-2) Production of Molded Product

The coated magnetic materials provided as above were used to produce molded products for iron loss evaluation as described above for the evaluation method for iron loss. Moreover, the coated magnetic material of Example 27 was used to produce a molded product for coating evaluation as described above for the evaluation methods for coating thickness and atomic concentrations.

The iron loss was measured on the molded products by the method described above. Table 2 shows the results.

TABLE 2

| | | | | | | Iron |
|---|---|---|---|---|---|---|
| | Soft | | pH | | | loss |
| | magnetic | Coating | adjustment | | Compound of metallic element or | W |
| | material | procedure | procedure | Phosphate compound | semimetallic element | (W/kg) |
| Ex. 1 | Commercial | YES | YES | Orthophosphoric acid, sodium dihydrogen phosphate | Samarium chloride (SmCl₃), | 383.2 |
| | iron powder | | | | sodium molybdate (Na₂MoO₄•2H₂O) | |
| Ex. 2 | Commercial | YES | YES | Orthophosphoric acid, sodium dihydrogen phosphate | Samarium chloride (SmCl₃) | 674.2 |
| | iron powder | | | | | |
| Ex. 3 | Fe—X | YES | YES | Orthophosphoric acid, sodium dihydrogen phosphate | Phosphotungstic acid hydrate | 398.4 |
| | | | | | (P₂O₅•24WO₃• × H₂O) | |
| Ex. 4 | Fe—X | YES | YES | Orthophosphoric acid, sodium dihydrogen phosphate | Zinc chloride (ZnCl₂) | 414.4 |
| Ex. 5 | Fe—X | YES | YES | Orthophosphoric acid, sodium dihydrogen phosphate | Iron chloride (FeCl₂) | 389.0 |
| Ex. 6 | Fe—X | YES | YES | Orthophosphoric acid, sodium dihydrogen phosphate | Hafnium chloride (HfCl₄) | 383.3 |
| Ex. 7 | Fe—X | YES | YES | Orthophosphoric acid, sodium dihydrogen phosphate | Titanium chloride (TiCl₄) | 352.8 |
| Ex. 8 | Fe—X | YES | YES | Orthophosphoric acid, sodium dihydrogen phosphate | Zirconium chloride (ZrCl₄) | 392.2 |
| Ex. 9 | Fe—X | YES | YES | Orthophosphoric acid, sodium dihydrogen phosphate | Nickel chloride (NiCl₂) | 336.4 |
| Ex. 10 | Fe—X | YES | YES | Orthophosphoric acid, sodium dihydrogen phosphate | Neodymium chloride (NdCl₃) | 315.2 |
| Ex. 11 | Fe—X | YES | YES | Orthophosphoric acid, sodium dihydrogen phosphate | Calcium chloride (CaCl₂) | 330.5 |
| Ex. 12 | Fe—X | YES | YES | Orthophosphoric acid, sodium dihydrogen phosphate | Barium chloride (BaCl₂) | 329.5 |
| Ex. 13 | Fe—X | YES | YES | Orthophosphoric acid, sodium dihydrogen phosphate | Sodium chloride (NaCl) | 324.7 |
| Ex. 14 | Fe—X | YES | YES | Orthophosphoric acid, sodium dihydrogen phosphate | Chromium chloride (CrCl₃) | 316.8 |
| Ex. 15 | Fe—X | YES | YES | Orthophosphoric acid, sodium dihydrogen phosphate | Aluminum chloride (AlCl₃) | 296.9 |
| Ex. 16 | Fe—X | YES | YES | Orthophosphoric acid, sodium dihydrogen phosphate | Vanadium chloride (VCl₃) | 296.4 |
| Ex. 17 | Fe—X | YES | YES | Orthophosphoric acid, sodium dihydrogen phosphate | Potassium chloride (KCl) | 312.3 |
| Ex. 18 | Fe—X | YES | YES | Orthophosphoric acid, sodium dihydrogen phosphate | Manganese chloride (MnCl₂) | 333.9 |
| Ex. 19 | Fe—X | YES | YES | Orthophosphoric acid, sodium dihydrogen phosphate | Magnesium chloride (MgCl₂) | 306.4 |
| Ex. 20 | Fe—X | YES | YES | Orthophosphoric acid, sodium dihydrogen phosphate | Aqueous sodium silicate (Na₂SiO₄) | 278.7 |
| Ex. 21 | Fe—X | YES | YES | Orthophosphoric acid, sodium dihydrogen phosphate | Cerium chloride (CeCl₃) | 274.7 |
| Ex. 22 | Fe—X | YES | YES | Orthophosphoric acid, sodium dihydrogen phosphate | Tantalum chloride (TaCl₅) | 248.1 |
| Ex. 23 | Fe—X | YES | YES | Orthophosphoric acid, sodium dihydrogen phosphate | Lanthanum chloride (LaCl₃) | 252.2 |
| Ex. 24 | Fe—X | YES | YES | Orthophosphoric acid, sodium dihydrogen phosphate | Dysprosium chloride (DyCl₃) | 210.3 |
| Ex. 25 | Fe—X | YES | YES | Orthophosphoric acid, sodium dihydrogen phosphate | Samarium chloride (SmCl₃) | 225.5 |
| Ex. 26 | Fe—X | YES | YES | Orthophosphoric acid, sodium dihydrogen phosphate | Molybdenum chloride (MoCl₅) | 168.1 |
| Ex. 27 | Fe—X | YES | YES | Orthophosphoric acid, sodium dihydrogen phosphate | Samarium chloride (SmCl₃), | 142.4 |
| | | | | | sodium molybdate | |
| | | | | | (Na₂MoO₄:2H₂O) | |
| Ex. 28 | Fe—X | YES | YES | Orthophosphoric acid, sodium dihydrogen phosphate | Sodium niobate (NaNbO₃) | 309.9 |
| Comp. | Commercial | NO | NO | — | — | 1512.0 |
| Ex. 1 | iron powder | | | | | |
| Comp. | Commercial | YES | NO | Orthophosphoric acid, sodium dihydrogen phosphate | Samarium chloride (SmCl₃) | 1022.2 |
| Ex. 2 | iron powder | | | | | |
| Comp. | Fe—X | NO | NO | — | — | 463.9 |
| Ex. 3 | | | | | | |

### Ex.: Example

### Comp. Ex.: Comparative Example

In Table 2, the columns for the coating procedure and the pH adjustment procedure are marked with “YES” for the test examples in which these procedures were performed and “NO” for the test examples in which these procedures were not performed. Examples 1 and 2 showed lower iron losses compared to Comparative Example 1 in which the same soft magnetic material was used but the coating procedure and the pH adjustment procedure were not performed. Similarly, Examples 3 to 28 showed lower iron losses compared to Comparative Example 3 in which the same soft magnetic material was used but the coating procedure and the pH adjustment procedure were not performed. Example 2 showed lower iron loss compared to Comparative Example 2 in which the same soft magnetic material and the same metallic element compound were used but only the coating procedure was performed.

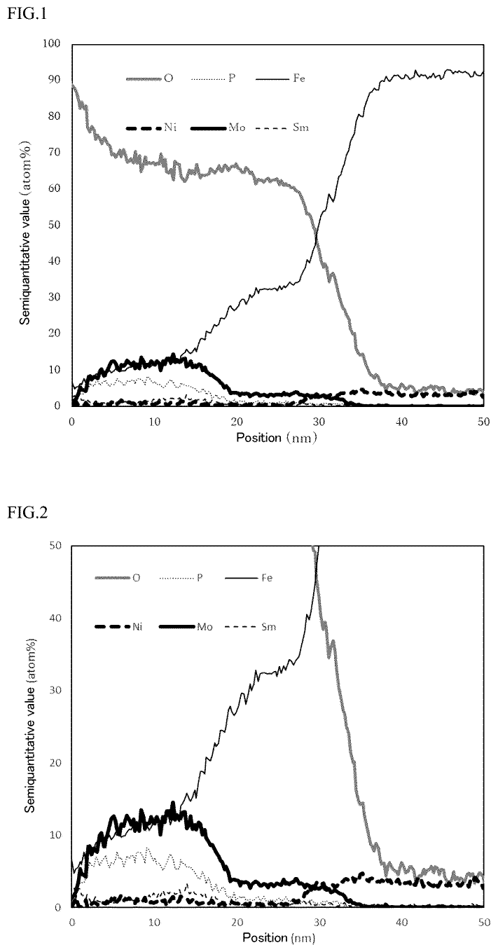

The line scan results of metallic elements, P, and O around the surface of the molded product for coating evaluation using the coated magnetic material of Example 27 are shown in FIGS. 1 and 2. FIG. 2 is an enlarged view of the region from 0 to 50 atom % in FIG. 1.

In FIGS. 1 and 2, the thickness of the coating on the surface of the magnetic material was about 30 nm. In FIG. 2, O was present in a larger amount than P throughout the coating. In the direction from the surface of the coating toward the magnetic material, there were two regions with different Mo contents. The average Mo content in the region closer to the magnetic material was lower than the average Mo content in the region farther from the magnetic material. Mo is probably derived from the sodium molybdate added in the coating procedure and the pH adjustment procedure.

What is claimed is:

1. A method of producing a coated magnetic material, comprising:
a coating procedure comprising mixing a first aqueous solution containing a first phosphate compound and a first compound of a first metallic element or a first semimetallic element with a soft magnetic material to form a first coating containing phosphate and the first metallic element or the first semimetallic element on a surface of the soft magnetic material; and
a pH adjustment procedure comprising mixing a second aqueous solution containing a second phosphate compound and a second compound of a second metallic element or a second semimetallic element with the soft magnetic material on which the first coating is formed, and adjusting a pH of a mixture of the second aqueous solution and the soft magnetic material on which the first coating is formed to form a second coating containing phosphate and the second metallic element or the second semimetallic element on a surface of the soft magnetic material on which the first coating is formed.

2. The method of producing a coated magnetic material according to claim 1,
wherein in the pH adjustment procedure, the pH of the mixture is adjusted to a pH lower than a pH of a mixture of the first aqueous solution and the soft magnetic material used in the coating procedure.

3. The method of producing a coated magnetic material according to claim 1,
wherein the second aqueous solution used in the pH adjustment procedure is obtained by adding the compound of the second metallic element or the second semimetallic element to the first aqueous solution used in the coating procedure.

4. The method of producing a coated magnetic material according to claim 1,
wherein the second compound of the second metallic element or the second semimetallic element used in the pH adjustment procedure is different from the first compound of the first metallic element or the first semimetallic element used in the coating procedure.

5. The method of producing a coated magnetic material according to claim 1,
wherein in the coating procedure, an aqueous solution containing the compound of the first metallic element or the first semimetallic element is mixed with the soft magnetic material and then with the first phosphate compound.

6. The method of producing a coated magnetic material according to claim 1,
wherein in the pH adjustment procedure, an inorganic acid is added to the second aqueous solution to adjust the pH to at least 1 but not higher than 4.5.

7. The method of producing a coated magnetic material according to claim 1,
wherein the first metallic element or the first semimetallic element used in the coating procedure is at least one selected from the group consisting of Mo, W, Zn, Fe, Hf, Ti, Zr, Ni, Ca, Ba, Na, Cr, V, K, Mn, Mg, Si, and Ta.

8. The method of producing a coated magnetic material according to claim 1,
wherein the second metallic element or the second semimetallic element used in the pH adjustment procedure is at least one selected from the group consisting of Mo, W, Zn, Fe, Hf, Ti, Zr, Ni, Ca, Ba, Na, Cr, V, K, Mn, Mg, Si, and Ta.

9. A method of producing a molded product, comprising:
obtaining a coated magnetic material by the method according to claim 1; and
heating the coated magnetic material.

10. A coated magnetic material, comprising:
a soft magnetic material; and
a coating provided on a surface of the soft magnetic material,
wherein the coating comprises, in an order from a soft magnetic material side, a first region containing a first M component and phosphorus and a second region containing a second M component and phosphorus,
an average amount of the first M component in the first region is less than an average amount of the second M component in the second region, and
the first M component and the second M component are each at least one selected from the group consisting of Mo, W, Zn, Fe, Hf, Ti, Zr, Ni, Ca, Ba, Na, Cr, V, K, Mn, Mg, Si, and Ta.
